(19) United States
(12) Patent Application Publication
(10) Pub. No.: US 2012/0101673 A1
(43) Pub. Date: Apr. 26, 2012

(54) Hybrid Vehicle Control System For Cold Plate Refrigeration And Method Of The Same

(76) Inventors: Jeffrey Andrew Caddick, Evansville, IN (US); Robert Eugene Utter, Adrian, MI (US)

(21) Appl. No.: 12/911,873

(22) Filed: Oct. 26, 2010

(51) Int. Cl. B60W 10/30; B60W 10/26; B60W 20/00

(52) U.S. Cl. 701/22; 180/65.275; 903/904

(57) ABSTRACT

A hybrid vehicle control system for cold plate refrigeration and method of the same. The hybrid vehicle control system for cold plate refrigeration uses inputs from sensors which read parameters such as battery voltage, environmental temperature, vehicle temperature, door status, fan status, refrigerant pressure, and mechanical cooling system status. The hybrid vehicle control system for cold plate refrigeration then assesses the inputs and outputs commands to operate fans, a mechanical cooling system, and alarms. The hybrid vehicle control system is capable of both cooling a vehicle refrigeration compartment or initiating a defrost cycle with a heater and hot gas to heat the refrigeration compartment.

### FIELD OF THE INVENTION

The present disclosure is in the technical field of vehicle power and control systems for cold plate refrigeration and methods for the same. More particularly, the present disclosure focuses on control systems and methods for controlling hybrid vehicles.

### BACKGROUND OF THE INVENTION

Commercial motor vehicles such as medium or heavy duty trucks at times are used to carry perishable items such as foods. One of the methods of keeping these perishable items fresh is by use of “Cold Plate” technology. “Cold Plate” refrigeration relies upon aluminum or other metal containers (cold plates) filled with a solution having a pre-determined freezing point. Prior to vehicle operation, typically overnight, the vehicle on-board refrigerant compressor is operated to bring the cold plates to a frozen condition. The vehicle then typically departs in the morning for its delivery rounds. The refrigerated cargo is maintained at a proper temperature until the cold plate solution thaws. Cold plate refrigeration is reliable, energy efficient, and capable of maintaining a relatively precise temperature which is ideal for milk and temperature sensitive foods. The major limitation of cold plate refrigeration systems is that the usable operation time is typically limited to the time that it takes for the cold plate solution to thaw. This typically limits vehicle usage to a single shift of operation.

U.S. Patent Application Publication 2007/0209378 by Larson describes a vehicle integrated power and control system and strategy for cold plate refrigeration which overcomes the limitation discussed above. U.S. Patent Application Publication 2007/0209378 is herein incorporated by reference in its entirety.

### BRIEF SUMMARY OF THE INVENTION

The present disclosure describes a hybrid vehicle control system for cold plate refrigeration and method of the same. The hybrid vehicle control system for cold plate refrigeration comprises: a computing environment; one or more temperature measuring devices which provide temperature data to the computing environment; a pressure measuring device which provides pressure data to the computing environment; a shore power relay which provides discrete data to the computing environment; a door switch which provides discrete data to the computing environment; one or more fans which are operatively connected to the computing environment; a mechanical cooling system which is operatively connected to the computing environment; one or more hot gas (HG) valves which are operatively connected to the computing environment; a vehicle battery which provides power to the computing environment and fans; and a hybrid high voltage DC battery which is operatively connected to the computing environment and provides power to the mechanical cooling system.

In a separate embodiment, the hybrid vehicle control system for cold plate refrigeration further comprises a voltage measuring device which provides voltage data to the computing environment.

Examples of computing environments include personal computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments, program logic controllers (PLCs), and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

The voltage measuring device measures the vehicle battery voltage and provides the information to the computing environment. The computing environment has a predetermined voltage set-point such as 12.5 volts. If the voltage is above the set-point, the hybrid vehicle battery can provide operating power to the fans and computing environment. The vehicle battery can be charged by the vehicle engine charging system, the hybrid high voltage battery (through a DC-DC converter), or a battery charger powered by shore power when shore power is available. In a separate embodiment, the voltage measuring device incorporates a relay to provide power to the fans and compressor.

The temperature measuring device can be a resistance temperature device (RTD), thermocouple, thermistor, or the like. Temperature data is used to determine whether or not electrical power is required for the fans and compressor.

The pressure measuring device is a pressure sensor and transmitter located on the mechanical cooling system which measures low-side refrigerant pressure. In an alternate embodiment, the sensor is combined with a switch instead of a transmitter and discrete data is sent to the computing environment.

The shore power relay can be a switch which notifies the computing environment if an external power source is being used to power the mechanical cooling system and a battery charger. The battery charger provides power to the vehicle battery.

The fans circulate air within the volume that is being temperature-controlled. The fans distribute cooling from the cold plates to the refrigerated volume.

The compressor is used to circulate refrigerant within a cooling loop which maintains cold plate temperature.

The hybrid vehicle control method for cold plate refrigeration comprises: using a computing environment; using one or more temperature measuring devices which provide temperature data to the computing environment; using a pressure measuring device which provides pressure data to the computing environment; using a shore power relay which provides discrete data to the computing environment; using a door switch which provides discrete data to the computing environment; operating one or more fans which are operatively connected to the computing environment; operating a mechanical cooling system which is operatively connected to the computing environment; operating one or more hot gas (HG) valves which are operatively connected to the computing environment; operating a vehicle battery which provides power to the computing environment and fans; and operating a hybrid high voltage DC battery which is operatively connected to the computing environment and provides power to the mechanical cooling system.

A separate embodiment of the method further comprises using the hybrid vehicle control method for operating a defrost cycle.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows an embodiment of the hybrid vehicle control system for cold plate refrigeration.

FIG. 2 shows Part A of a flow chart with an embodiment of the hybrid vehicle control method for cold plate refrigeration.

FIG. 3 shows Part B of a flow chart with an embodiment of the hybrid vehicle control method for cold plate refrigeration.

FIG. 4 shows Part C of a flow chart with an embodiment of the hybrid vehicle control method for cold plate refrigeration.

FIG. 5 shows Part D of a flow chart with an embodiment of the hybrid vehicle control method for cold plate refrigeration.

### DETAILED DESCRIPTION OF THE INVENTION

Hybrid vehicles utilize two different energy sources to power the vehicle. This enables more efficient vehicle operation through reduced fuel consumption. The present disclosure describes a hybrid vehicle which utilizes electricity and diesel fuel to power the vehicle. Electricity can be generated when braking the truck instead of wasting it as heat. The type of hybrid vehicle described is a commercial truck which utilizes cold plate technology for chilled cargo.

Since the hybrid vehicle described can generate electricity and store it on the vehicle, there are unique opportunities for efficient electricity usage that don't exist in a standard diesel truck. These opportunities create their own set of challenges, which have non-obvious solutions and unexpected benefits.

First, dual mode operation of either shore power or hybrid power requires different control schemes. Hybrid power is dependent on hybrid battery voltage, which is limited if the truck is not operating.

Second, defrosting is performed only with shore power. In practice, defrosting is only required when the truck is not operating.

Third, an auto sequential defrost strategy is used.

Fourth, the defrost has some time logic which allows shore power interruption while still completing defrost. This enables the hybrid vehicle to move around during loading and still complete the defrost cycle.

Fifth, a shore power delay is incorporated to ensure a solid power connection prior to shore power operation.

Sixth, there is a hybrid start time delay which ensures that there is no plate refreezing if there is a return to shore power defrost.

Seventh, there are multiple low pressure settings based on which operating mode is used; hybrid power, shore power normal, or shore power defrost.

Eighth, there is the ability to operate the heater with either shore power, hybrid power, or both to prevent freezing.

One benefit of the hybrid vehicle control system for cold plate refrigeration is that less mechanical cooling system capacity is needed, since the hybrid vehicle control system for cold plate refrigeration can maintain a steady state. Hence, a smaller compressor and smaller cold plates are required. This results in lower capital costs, lower operational costs, and lower maintenance costs. Overall truck operation is more efficient since less weight is being transported and less fuel is being used. Furthermore, the start-up and defrost cycles are both faster and less expensive since the system is smaller.

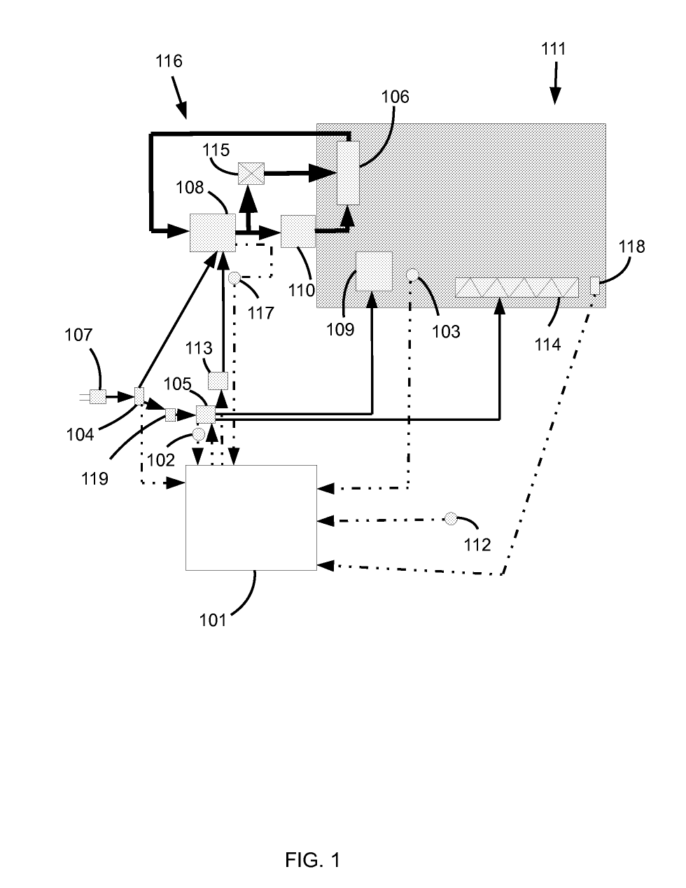

FIG. 1 shows an embodiment of the hybrid vehicle control system for cold plate refrigeration. Signal wire lines are shown with two dots and a dash. The computing environment 101 receives data from a voltage measuring device 102, a refrigeration compartment temperature measuring device 103, a relay 104, a pressure measuring device 117, a door switch 118, and an ambient temperature measuring device 112. The voltage measuring device 102 measures vehicle battery 105 voltage. The refrigeration compartment temperature measuring device 103 measures refrigeration compartment temperature. The relay 104 determines if shore power 107 is being used. If shore power 107 is being used, power flows through the relay 104 to a battery charger 119, which charges the vehicle battery 105. The ambient temperature measuring device 112 measures outside air. Based on the data, the computing environment 101 determines whether a compressor 108 and one or more fans 109 should operate using power from a hybrid high voltage DC battery 113 for the compressor 108 and power from the vehicle battery 105 for the fans 109. When operating, the compressor 108 compresses refrigerant in a closed-loop 116, which then flows to a condenser 110, where heat is removed to change the refrigerant from a vapor to a liquid. The refrigerant then flows to cold plates 106, where it is expanded to a gas to cool the cold plates 106 and then returns in the closed-loop 116 to be compressed again. Cold plates 106 and circulation fans 109 are located within the vehicle refrigeration compartment 111. When operating the defrost cycle, a hot gas (HG) valve 115 allows hot gas to circulate through a selected plate, 106. (HG) valve 115 can also be a plurality of valves working in unison. When operating in heating mode, heater 114 is energized to prevent freezing in refrigeration compartment 111.

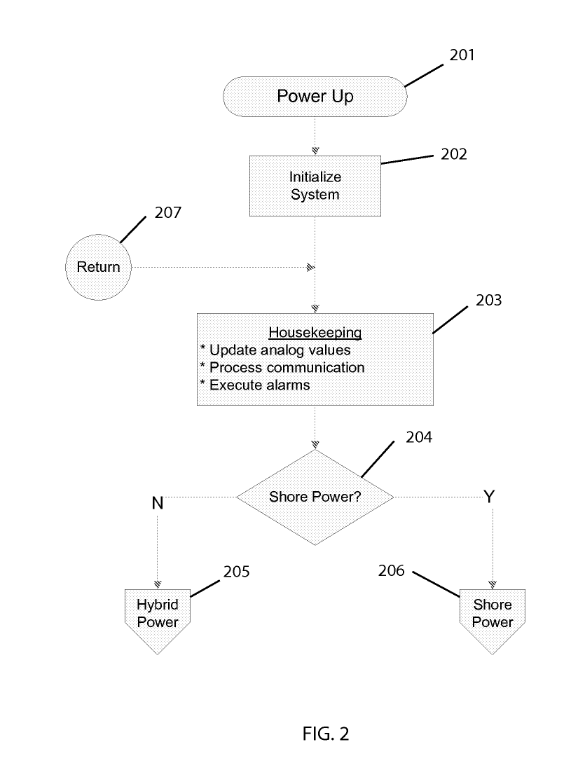

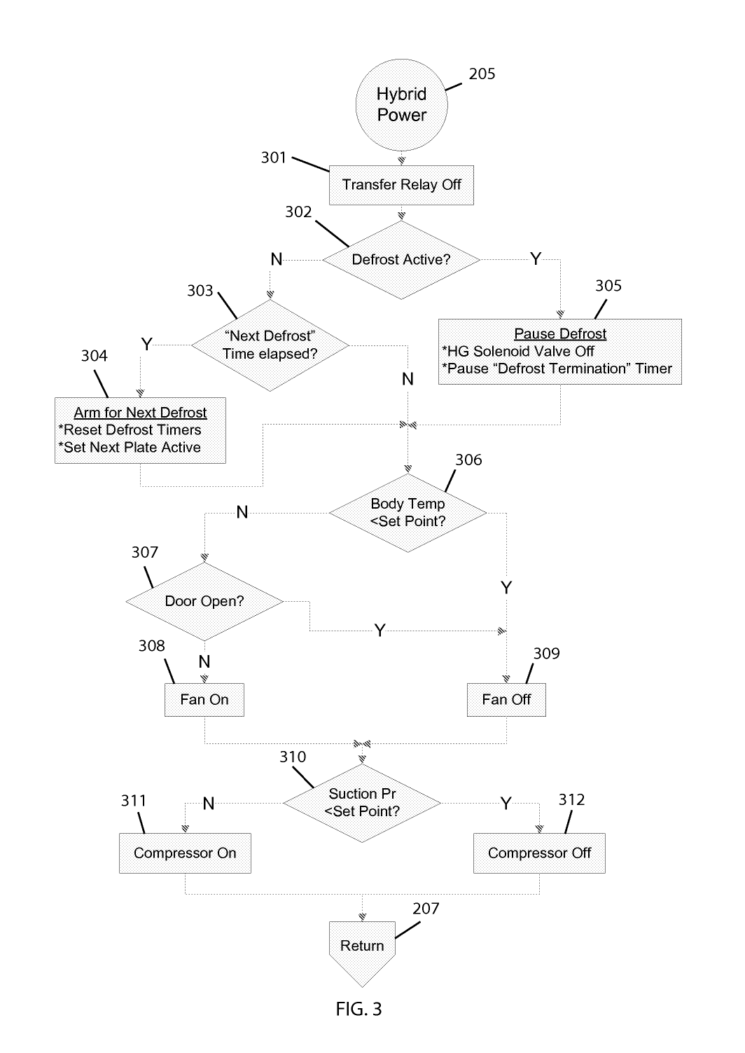

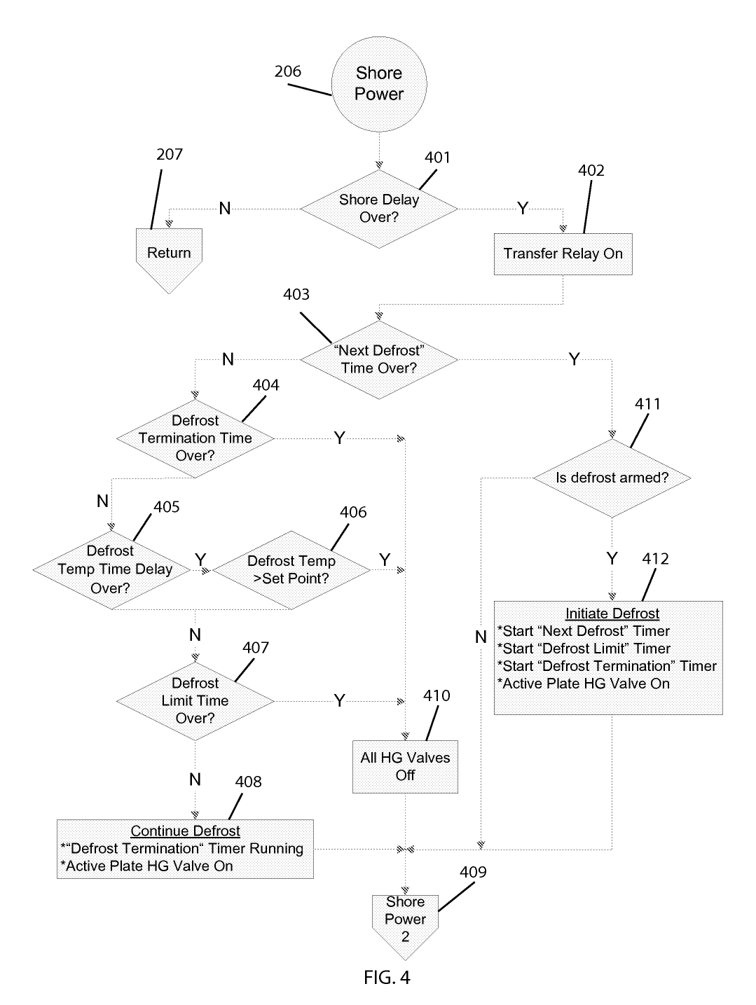

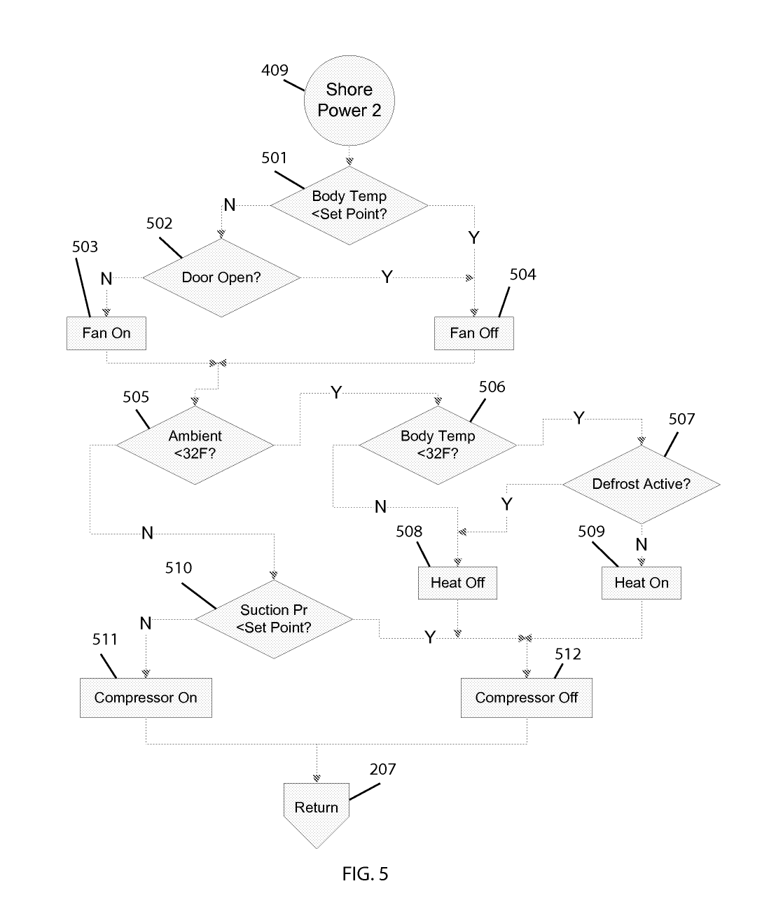

FIG. 2 shows Part A of a flow chart with an embodiment of the hybrid vehicle control method for cold plate refrigeration. Step 201 is the power-up of the hybrid vehicle control system for cold plate refrigeration. Step 202 initializes the system. Step 203 is a diagnostic check and housekeeping functions. Step 204 determines whether the shore power is being supplied to the system. If there is no shore power, step 205 is initiated, which is the subroutine for hybrid power (FIG. 3). If there is shore power, step 206 is initiated, which is the subroutine for shore power (FIG. 4 and FIG. 5). Step 207 shows a logic return from a hybrid power or shore power subroutine.

FIG. 3 shows Part B of a flow chart with an embodiment of the hybrid vehicle control method for cold plate refrigeration. Part B is the hybrid power subroutine. Step 205, hybrid power, carries over from FIG. 2. Step 301 ensures that the shore power transfer relay is off. Step 302 queries if the system is being defrosted. If the system is not being defrosted, step 303 queries if the next defrost time has elapsed. If the next defrost time has elapsed, step 304 arms the system for the next defrost by resetting the defrost timers and setting the next cold plate as active. If the system is currently being defrosted, step 305 interrupts the defrost cycle since defrosting should only occur when shore power is being used. Step 306 queries if the body temperature (i.e. refrigeration compartment temperature) is below a set-point. If the body temperature is not below the set-point, step 307 queries if the refrigeration compartment door is open. If the body temperature is not below the programmable set-point and the refrigeration compartment door is not open, step 308 turns on the circulation fans. If the body temperature is below the set-point or the refrigeration compartment door is open, step 309 turns off the circulation fans. Step 310 queries if the compressor suction pressure is below a pressure set-point. If the suction pressure is not below the pressure set-point, step 311 turns the compressor on and then the system returns to step 207. If the suction pressure is below the pressure set-point, step 312 turns the compressor off and then the system returns to step 207.

FIG. 4 shows Part C of a flow chart with an embodiment of the hybrid vehicle control method for cold plate refrigeration. Part C is the first section of the shore power subroutine. Step 206, shore power, carries over from FIG. 2. Step 401 queries if the shore power delay is over. If the shore power delay is not over, the system returns to step 207. If the shore power delay is over, step 402 turns on the transfer relay and step 403 queries if the “next defrost” time is over. If the “next defrost” time is not over, step 404 queries if the defrost termination time is over. If the defrost termination time is not over, step 405 queries if the defrost temperature time delay is over, so that the defrost is not prematurely stopped. If the defrost termination time is not over, step 406 queries if the defrost temperature is greater than the defrost termination set-point temperature. If the defrost temperature is not greater than the defrost termination set-point temperature, step 407 queries if the defrost limit time is over. If the defrost limit time is not over, step 408 continues the defrost cycle and then step 409 continues the shore power subroutine with the second section (FIG. 5). If the defrost termination time is over, the defrost temperature is greater than the defrost termination set-point temperature, or the defrost limit time is over, step 410 turns all HG valves off and then step 409 continues the shore power subroutine with the second section (FIG. 5). If the “next defrost” time is over, step 411 queries if the defrost sequence is armed. If the defrost sequence is not armed, step 409 continues the shore power subroutine with the second section (FIG. 5). If the defrost sequence is armed, step 412 initiates the defrost sequence by starting the next defrost timer, starting the defrost limit timer, starting the defrost termination timer, and turning the active plate HG valves on. After step 412, step 409 continues the shore power subroutine with the second section (FIG. 5).

FIG. 5 shows Part D of a flow chart with an embodiment of the hybrid vehicle control method for cold plate refrigeration. Part D is the second section of the shore power subroutine. Step 409, shore power 2, carries over from FIG. 4. Step 501 queries if the body temperature (i.e. refrigeration compartment temperature) is below a set-point. If the body temperature is not below the programmable set point, step 502 queries if the refrigeration compartment door is open. If the body temperature is not below the programmable set point and the refrigeration compartment door is not open, step 503 turns the circulation fans on. If the body temperature is below the programmable set point or the refrigeration compartment door is open, step 504 turns the circulation fans off. Step 505 queries if the ambient (outdoor) temperature is less than 32 degrees Fahrenheit. If the ambient (outdoor) temperature is less than 32 degrees Fahrenheit, step 506 queries if the body temperature (i.e. refrigeration compartment temperature) is below 32 degrees Fahrenheit. If the ambient (outdoor) temperature is less than 32 degrees Fahrenheit and body temperature is below 32 degrees Fahrenheit, step 507 queries if the defrost cycle is active. If the ambient (outdoor) temperature is less than 32 degrees Fahrenheit and the body temperature is not below 32 degrees Fahrenheit or if the ambient (outdoor) temperature is less than 32 degrees Fahrenheit, the body temperature is below 32 degrees Fahrenheit, and the defrost cycle is active, then step 508 turns the heater off, step 512 turns the compressor off, and the system returns to step 207. If the ambient (outdoor) temperature is less than 32 degrees Fahrenheit, the body temperature is below 32 degrees Fahrenheit, and the defrost cycle is not active, step 509 turns the heater on, step 512 turns the compressor off, and the system returns to step 207. If the ambient (outdoor) temperature is not less than 32 degrees Fahrenheit, step 510 queries if the compressor suction pressure is below a pressure set-point. If the compressor suction pressure is not below a pressure set-point, step 511 turns the compressor on and the system returns to step 207. If the compressor suction pressure is below a pressure set-point, step 512 turns the compressor off and the system returns to step 207.

For the purposes of this disclosure, the vehicle battery comprises one or more batteries which form a reservoir of stored electrical energy.

For the purposes of this disclosure, the hybrid high voltage DC battery comprises one or more batteries which form a reservoir of stored electrical energy.

For the purposes of this disclosure, hot gas (HG) valve refers to a solenoid valve that regulates the flow of refrigerant to cause hot gas to flow through a selected plate for the purpose of defrosting that plate rather than freezing it.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

We claim:

1. A hybrid vehicle control system for cold plate refrigeration, the system comprising:
a computing environment;
one or more temperature measuring devices which provide temperature data to the computing environment;
a pressure measuring device which provides pressure data to the computing environment;
a shore power relay which provides discrete data to the computing environment;
a door switch which provides discrete data to the computing environment;
one or more fans which are operatively connected to the computing environment;
a mechanical cooling system which is operatively connected to the computing environment;
one or more hot gas (HG) valves which are operatively connected to the computing environment;
a vehicle battery which provides power to the computing environment and fans; and
a hybrid high voltage DC battery which is operatively connected to the computing environment and provides power to the mechanical cooling system.

2. The system of claim 1, further comprising a voltage measuring device with an integrated relay to provide power from the vehicle battery to the one or more fans when the vehicle battery voltage outputs greater than a predetermined set point value.

3. The system of claim 1, wherein the mechanical cooling system further comprises a soft start circuit to limit the initial power that the hybrid high voltage DC battery provides to the mechanical cooling system.

4. The system of claim 2, wherein the mechanical cooling system further comprises a soft start circuit to limit the initial power that the hybrid high voltage DC battery provides to the mechanical cooling system.

5. A hybrid vehicle control method for cold plate refrigeration, the method comprising:
using a computing environment;
using one or more temperature measuring devices which provide temperature data to the computing environment;
using a pressure measuring device which provides pressure data to the computing environment;
using a shore power relay which provides discrete data to the computing environment;
using a door switch which provides discrete data to the computing environment;
operating one or more fans which are operatively connected to the computing environment;
operating a mechanical cooling system which is operatively connected to the computing environment;
operating one or more hot gas (HG) valves which are operatively connected to the computing environment;
operating a vehicle battery which provides power to the computing environment and fans; and
operating a hybrid high voltage DC battery which is operatively connected to the computing environment and provides power to the mechanical cooling system.

6. The method of claim 5, further comprising using a voltage measuring device with an integrated relay to provide power from the vehicle battery to the one or more fans when the vehicle battery output voltage is greater than a predetermined set point value.

7. The method of claim 5, further comprising limiting the initial power that the hybrid high voltage DC battery provides to the mechanical cooling system with a soft start circuit.

8. The method of claim 6, further comprising limiting the initial power that the hybrid high voltage DC battery provides to the mechanical cooling system with a soft start circuit.

9. The method of claim 5, further comprising operating a defrost cycle when the computing environment determines that the defrost cycle is necessary.
